(19) United States
(12) Patent Application Publication
(10) Pub. No.: US 2008/0075991 A1
(43) Pub. Date: Mar. 27, 2008

(54) Monitoring and control of fuel cell purge to emit non-flammable exhaust streams

(76) Inventors: Arne LaVen, Bend, OR (US); Alan Menard, Bend, OR (US); Curtiss Renn, Bend, OR (US); Douglas B. Suckow, Bend, OR (US)

Correspondence Address: KOLISCH HARTWELL, P.C., 520 SW YAMHILL STREET, Suite 200, PORTLAND, OR, 97204, US

(21) Appl. No.: 11/527,081

(22) Filed: Sep. 25, 2006

(51) Int. Cl. H01M 8/04; H01M 8/06

(52) U.S. Cl. 429/23; 429/34; 429/19; 429/13

(57) ABSTRACT

Systems and methods for monitoring and/or controlling fuel cell exhaust to provide a non-flammable exhaust stream. In some embodiments, operation of the fuel cell system is regulated to provide an exhaust stream that has a maximum flammability that is less than a predetermined fractional threshold of the lower flammability limit for the gases contained therein. In some embodiments, the systems and methods utilize the current produced by the fuel cell, or fuel cell stack, to monitor and/or regulate the flammability of the fuel cell exhaust stream. In some embodiments, the fuel cell system includes one or more controllers that are adapted to monitor the flammability of the exhaust stream from the fuel cell stack and/or to regulate the operation of the fuel cell system responsive thereto. In some embodiments, the operation and/or duty cycle of at least an anode purge valve is regulated or controlled responsive to the measured current.

### TECHNICAL FIELD

The present disclosure relates generally to fuel cell systems, and more particularly to systems and methods for controlling purging in a fuel cell system to prevent the emission of a flammable purge stream.

### BACKGROUND OF THE DISCLOSURE

An electrochemical fuel cell is a device that converts fuel and an oxidant to electricity, a reaction product, and heat. For example, fuel cells may be adapted to convert hydrogen and oxygen into water, electricity, and heat. In such fuel cells, the hydrogen is the fuel, the oxygen is the oxidant, and the water is the reaction product.

A fuel cell stack assembly includes at least one fuel cell, and typically two or more fuel cells, including groups of fuel cells, coupled together as a unit. A fuel cell stack assembly may be incorporated into a fuel cell system. A fuel cell system also typically includes a fuel source, such as a supply of fuel and/or a fuel processor, which produces hydrogen gas or another suitable proton source for the fuel cell stack assembly from one or more feedstocks. An illustrative example of a fuel processor is a steam reformer, which produces hydrogen gas from water and a carbon-containing feedstock.

In a fuel cell system in which oxygen gas is the oxidant, the oxygen gas is frequently provided to the fuel cell stack assembly as part of an oxidizer, or oxidant stream, which may also include a dilutant. An example of an oxidizer suitable for fuel cell systems is air, which may be considered to essentially be a mixture of nitrogen gas and oxygen gas in predetermined proportions. A fuel cell system may include an oxidizer source that provides air to the fuel cell stack assembly such as a blower, fan, compressor, or other suitable alternative air delivery assembly.

During operation, a fuel cell stack assembly will (continuously or intermittently) emit exhaust to the surroundings of the fuel cell system, which may include non-consumed supply gases, such as fuels, oxidants, and/or dilutants, and reaction products. Some of these exhaust components, especially fuels, may be flammable at specific levels. Accordingly, fuel cell systems that employ air as an oxidizer typically include systems to measure directly the flow rate of the air through the fuel cell stack assembly in order to determine how much fuel can be diluted in an exhaust stream comprising an exhaust fuel and an exhaust oxidizer in order to maintain the concentration of the fuel in the exhaust stream below a flammability limit of the fuel. These systems, which may include flow meters and the like, add complexity and reliability concerns to the fuel cell system.

### BRIEF DESCRIPTION OF THE DRAWINGS

FIG. 1 is a schematic view of a fuel cell and an associated fuel source and oxidant source.

FIG. 2 is a schematic view of a fuel cell system including a fuel cell stack assembly, a fuel source, an oxidant source, an exhaust assembly, and a control system.

FIG. 3 is a graph of the flammability range of hydrogen gas diluted in nitrogen gas, showing the corresponding oxygen concentration if the nitrogen is provided by an air stream.

FIG. 4 is the graph of FIG. 3 with curves showing various illustrative operating ratios of hydrogen-consuming fuel cell systems added.

FIG. 5 is a schematic view of a fuel cell system including a fuel cell stack assembly, a fuel source, an oxidant source, an exhaust assembly, and a control system including a functional controller and an interlock controller.

FIG. 6 is a schematic view of an illustrative control system of the fuel cell system of FIG. 5.

FIG. 7 is a schematic of an illustrative state diagram of the operation of the fuel cell system of FIG. 5.

### DETAILED DESCRIPTION AND BEST MODE OF THE DISCLOSURE

Methods and systems are disclosed for controlling the operation of a fuel cell stack assembly, including the purging, or exhausting, of gases therefrom. As used herein, a fuel cell stack assembly includes one or more fuel cells, whether individually or in groups of fuel cells, and typically includes a plurality of fuel cells coupled between common end plates. A fuel cell system includes one or more fuel cell stack assemblies, and at least one fuel source and at least one oxidant source for the at least one fuel cell stack assembly.

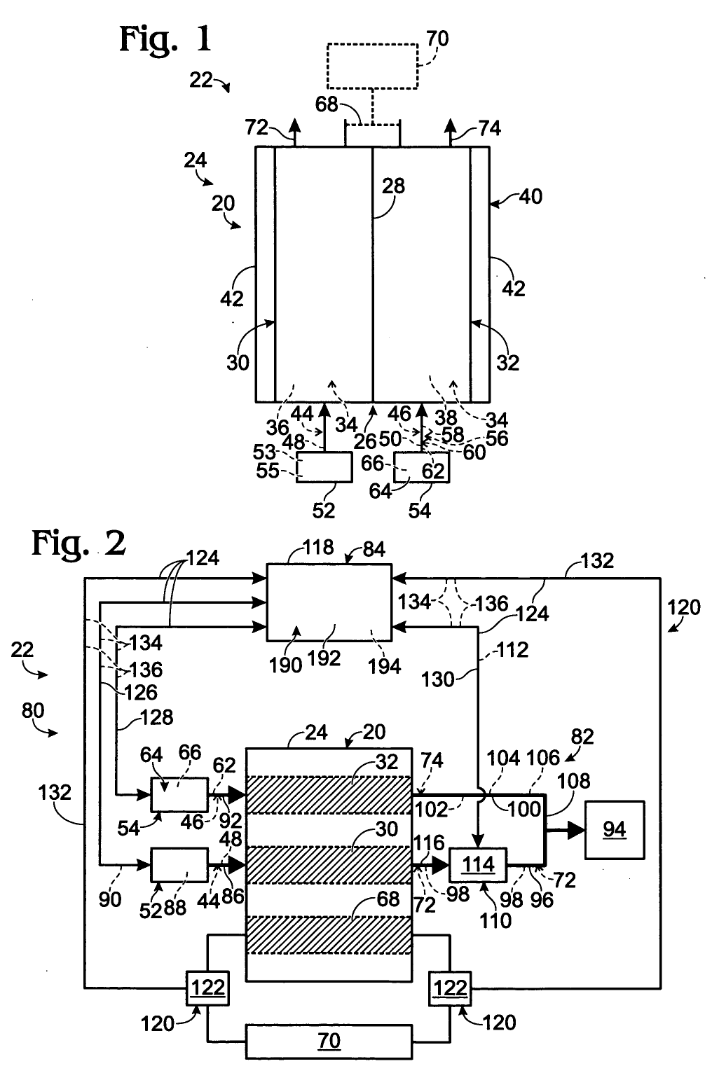

The subsequently discussed fuel cell stack assemblies and fuel cell systems are compatible with a variety of different types of fuel cells, such as proton exchange membrane (PEM) fuel cells, alkaline fuel cells, solid oxide fuel cells, molten carbonate fuel cells, phosphoric acid fuel cells, and the like. For the purpose of illustration, an illustrative fuel cell 20 in the form of a PEM fuel cell is schematically illustrated in FIG. 1. The fuel cell may be described as forming a portion of a fuel cell system, such as generally indicated at 22, and/or a portion of a fuel cell stack assembly, such as generally indicated at 24. Proton exchange membrane fuel cells typically utilize a membrane-electrode assembly 26 consisting of an ion exchange, or electrolytic, membrane 28 located between an anode region 30 and a cathode region 32. Each region 30 and 32 includes an electrode 34, namely an anode 36 and a cathode 38, respectively. Each region 30 and 32 also includes a support 40, such as a supporting plate 42. Support 40 may form a portion of a bipolar plate assembly between adjacent fuel cells. The supporting plates 42 of fuel cell 20 may carry the relative voltage potential produced by the fuel cell.

In operation, fuel 44 is fed to the anode region, while oxidant 46 is fed to the cathode region. Fuel 44 may also be referred to as supply fuel 44. A typical, but not exclusive, fuel for cell 20 is hydrogen 48, and a typical, but not exclusive, oxidant is oxygen 50. As used herein, hydrogen refers to hydrogen gas and oxygen refers to oxygen gas. Hydrogen 48 and oxygen 50 may be delivered to the respective regions of the fuel cell via any suitable mechanism from respective sources 52 and 54. Examples of suitable fuel sources 52 for hydrogen 48 include at least one pressurized tank, hydride bed or other suitable hydrogen storage device 53, and/or a fuel processor 55 that produces a stream containing hydrogen gas as a majority component. Some fuel cells, such as direct methanol fuel cells, utilize methanol as fuel 44.

When fuel source 52 includes a fuel processor 55 that is adapted to produce a product stream containing hydrogen 48, at least a portion of this product stream may be consumed as fuel 44 for a fuel cell stack assembly according to the present disclosure. At least a portion of the product stream may additionally or alternatively be stored for later use, such as in a suitable hydrogen storage device 53. Fuel processor 55 may be any suitable device that produces hydrogen gas from one or more feed streams. Examples of suitable mechanisms for producing hydrogen gas from a feed stream include steam reforming and autothermal reforming, in which reforming catalysts are used to produce hydrogen gas from at least one feed stream containing a carbon-containing feedstock and water. Other suitable mechanisms for producing hydrogen gas include pyrolysis and catalytic partial oxidation of a carbon-containing feedstock, in which case the feed stream does not contain water. Still another suitable mechanism for producing hydrogen gas is electrolysis, in which case the feedstock is water. Examples of suitable carbon-containing feedstocks include at least one hydrocarbon or alcohol. Examples of suitable hydrocarbons include methane, propane, natural gas, diesel, kerosene, gasoline and the like. Examples of suitable alcohols include methanol, ethanol, and polyols, such as ethylene glycol and propylene glycol.

The one or more feed streams may be delivered to fuel processor 55 via any suitable mechanism, such as via a feedstock delivery system. The feedstock delivery system may include one or more sources for the components of the feed stream(s) and/or may be in fluid communication with one or more external supplies for one or more of the components of the feed stream(s), including an external supply containing the entire feed stream. When present, the feedstock delivery system may include any suitable structure for controlling the delivery of the feed stream(s) to the fuel processor, such as to a hydrogen-producing region thereof. In some embodiments, the feedstock delivery system will include one or more pumps. Illustrative, non-exclusive examples of suitable fuel processors are disclosed in U.S. Pat. Nos. 6,221,117, 5,997,594, 5,861,137, and pending U.S. Patent Application Publication Nos. 2001/0045061, 2003/0192251, and 2003/0223926. The complete disclosures of the above-identified patents and patent applications are hereby incorporated by reference for all purposes.

Suitable oxidant sources 54 for oxygen 50 may be adapted to provide an oxidizer, or oxidant stream, 56 that includes oxygen gas diluted by a suitable dilutant 58 such as nitrogen gas 60. Examples of oxidizer 56 may include air 62, which includes nitrogen gas 60 and oxygen gas 50 at a predetermined ratio. The air may be provided by an oxidizer source 64, which may include a blower 66. Alternatively, oxidant source 54 may include a pressurized tank of oxygen or air, or a fan, compressor, or other device for directing air or some other suitable oxidizer to the cathode region of the fuel cell(s).

Hydrogen and oxygen typically combine with one another via an oxidation-reduction reaction. Although membrane 28 restricts the passage of a hydrogen molecule, it will permit a hydrogen ion (proton) to pass therethrough, largely due to the ionic conductivity of the membrane. The free energy of the oxidation-reduction reaction drives the proton from the hydrogen gas through the ion exchange membrane. As membrane 28 also tends not to be electrically conductive, an external circuit 68 is the lowest energy path for the remaining electron, and is schematically illustrated in FIG. 1.

In practice, fuel cell stack assembly 24 will typically contain a plurality of fuel cells 20 with bipolar plate assemblies separating adjacent membrane-electrode assemblies. The bipolar plate assemblies essentially permit the free electron to pass from the anode region of a first cell to the cathode region of the adjacent cell via the bipolar plate assembly, thereby establishing an electrical potential through the stack that may be used to satisfy an applied load 70. This net flow of electrons produces an electric current that may be used to satisfy the applied load, such as from at least one of an energy-consuming device, an energy-storing device, the fuel cell system itself, an energy-storing/consuming assembly, etc.

Load 70 has been schematically illustrated in FIG. 2 and is intended to generally represent one or more devices that apply an electrical load to a fuel cell stack assembly and/or fuel cell system according to the present disclosure. Load 70 may represent the applied load from one or more energy-consuming devices that are in electrical communication with the fuel cell stack assembly, and it may include an applied load from the fuel cell system itself. The applied load, or energy demands, of the fuel cell system may be referred to as the balance-of-plant requirements of the fuel cell system. Therefore, the electric current, or electrical output, produced by fuel cell stack assemblies 24 and systems containing the same according to the present disclosure may be adapted to satisfy the energy demands, or applied load, of at least one associated energy-consuming device. Illustrative examples of energy-consuming devices include, but should not be limited to, motor vehicles, recreational vehicles, construction or industrial vehicles, boats or other seacraft, tools, lights or lighting assemblies, appliances (such as household or other appliances), households or other dwellings, offices or other commercial establishments, computers, signaling or communication equipment, battery chargers, etc. Load 70, as schematically illustrated, may also represent suitable power management modules, or components, such as may include any suitable structure to convert the electric current produced by the fuel cell stack assembly to the appropriate power configuration for the corresponding energy-consuming device, such as by adjusting the voltage of the stream (i.e., with a buck or boost converter), the type of current (alternating or direct), etc.

In cathode region 32, electrons from an external circuit and protons from the membrane combine with oxygen to produce water and heat. Also schematically illustrated in FIG. 1 are an anode purge or discharge stream 72, which may contain unreacted fuel, such as hydrogen gas, and a cathode air exhaust stream 74, which may contain oxidizer, such as may be at least partially, if not substantially, depleted of oxygen. Fuel cell stack assembly 24 will typically have common hydrogen (or other fuel) feed, air intake, and stack purge and exhaust streams, and accordingly may include suitable fluid conduits to deliver the associated streams to, and collect the streams from, the individual fuel cells. Similarly, any suitable mechanism may be used for selectively purging the anode and cathode regions.

An illustrative, non-exclusive example of a fuel cell system 22 is shown in FIG. 2 and indicated generally at 80. Fuel cell system 80 may include a fuel cell stack assembly 24 that may include one or more fuel cells 20, and typically includes a plurality of fuel cells. For example, the fuel cell stack assembly may include one or more of the proton electron membrane (PEM) fuel cells that were schematically illustrated in FIG. 1. Fuel cell system 80 may also include fuel source 52, oxidant source 54, an exhaust assembly 82, a control system 84, and load 70. Fuel source 52 may supply fuel 44 that may include hydrogen gas 48 and may include a hydrogen storage device and/or a hydrogen-producing fuel processor. Fuel source 52 may be adapted to supply fuel 44 to fuel cell stack assembly 24 at a constant pressure or within a predetermined range of suitable pressures. The fuel may be delivered, via a suitable conduit 86, to anode region 30 of the at least one fuel cell 20 of fuel cell stack assembly 24. Fuel cell system 80 may include a fuel source cutoff module 88 that is adapted to be selectively actuated, in response to fuel source cutoff command signal 90, between an open configuration in which the fuel source is adapted to provide fuel to the fuel cell stack assembly and a closed configuration, in which the fuel source cutoff module is adapted to prevent fuel from being delivered to the fuel cell stack assembly 24. Command signal 90 may be sent by control system 84. Fuel source 52 may be adapted to respond to one or more additional command signals in order to initiate, cease, increase, or decrease the flow of fuel to the fuel cell stack assembly.

Oxidant source 54 may include an oxidizer source 64 that is adapted to provide air 62 to fuel cell stack assembly 24. Air 62 may be supplied to the fuel cell stack assembly by any suitable air delivery system, or mechanism. An illustrative example is a fan or air blower 66. Air may be delivered, via a suitable conduit 92, to cathode region 32 of the at least one fuel cell 20 of fuel cell stack assembly 24. Oxidant source 54, or, particularly, air blower 66 may be adapted to respond to one or more command signals in order to initiate, cease, increase, or decrease the flow of air to the fuel cell stack assembly.

Exhaust assembly 82 may include a stack exhaust 94 that is adapted to receive exhaust gases, which may include one or both of anode exhaust 72 and cathode exhaust 74, from the fuel cell stack assembly and to release these exhaust gases to the surroundings of the fuel cell system. Accordingly, exhaust assembly 82 may include a fuel purge conduit 96 that is adapted to transport anode exhaust 72, which typically includes an exhaust fuel 98, and an oxidizer exhaust conduit 100 that is adapted to transport cathode exhaust 74, which typically includes an exhaust oxidizer 102 which may include an exhaust oxidant 104 and an exhaust dilutant 106.

Exhaust assembly 82 may also include a combined exhaust conduit 108 that is in fluid communication with stack exhaust 94, fuel purge conduit 96, and oxidizer exhaust conduit 100. Accordingly, the fuel purge conduit and the oxidizer exhaust conduit may be in fluid communication with the stack exhaust, through which the fuel purge conduit may be in fluid communication with the surroundings of fuel cell system 80.

Exhaust oxidizer 102 may be emitted continuously or intermittently. As used herein, intermittently may include predefined periodic occurrences, as well as time-spaced occurrences that are triggered, or initiated, responsive to events other than simply the passage of a predetermined amount of time. In the example shown in FIG. 2, cathode exhaust 74 may continuously be transported through oxidizer exhaust conduit 100 whenever air blower 66 is operating to provide supply oxidizer 56 to the fuel cell stack assembly. In other examples, exhaust assembly 82 may include additional elements not shown to regulate the flow of exhaust oxidizer 102 from cathode region 32.

Fuel cell stack assembly 24 may include a fuel purge module 110 that is adapted to purge anode region 30 of fuel cell stack assembly 24. The fuel purge module may be adapted to be selectively actuated to control the exhaust stream of fuel from the fuel cell stack assembly. Exhaust fuel 98 may be emitted intermittently or continuously. In examples in which exhaust fuel 98 is emitted intermittently, the flow rate of the exhaust fuel may be considered on a time-averaged basis. In these embodiments, the flow of exhaust fuel may be considered to be continuous even though the physical anode discharge 72 may only be intermittent. The timing between purges, and the duration of each purge, may be fixed, variable, and/or may be determined by control system 84, as will be discussed in greater detail herein.

Fuel purge module 110 may be adapted to be selectively actuated, in response to at least one fuel purge command signal 112 such as from control system 84, to modulate a volume of exhaust fuel 98 that may be released into fuel purge conduit 96 and, in turn, to stack exhaust 94. In examples where fuel is exhausted intermittently, fuel purge module 110 may be adapted to be selectively actuated to transition between a closed configuration, in which the fuel purge module is adapted to prevent exhaust fuel from being introduced or released into the stack exhaust, and an open configuration, in which the fuel purge module is adapted to release a volume of exhaust fuel 98 into the fuel purge conduit 96 and, in turn, to stack exhaust 94. A non-exclusive example of fuel purge module 110 that is adapted to emit exhaust fuel 98 intermittently may include solenoid valve 114.

In examples where exhaust fuel is exhausted continuously, fuel purge module 110 may be adapted to be selectively actuated to regulate a volume of exhaust fuel 98 that may be released into the fuel purge conduit 96 and, in turn, to stack exhaust 94. Although not required to all embodiments, fuel purge module 110 may be adapted to emit a continuous, modulating stream of exhaust fuel. A non-exclusive example of fuel purge module 110 that is adapted to emit a continuously modulated stream of exhaust fuel may include an orifice adjusting valve or the like. Fuel purge module 110 may also include a combination of these elements, or a single element that performs a combination of these functions to intermittently emit a modulated stream of exhaust.

A fuel exhaust conduit 116 may transport the exhaust fuel from fuel cell 20 to the fuel purge module. A fuel cell stack assembly 24 that includes more than one fuel cell 20 may include a corresponding number of fuel exhaust conduits 116 that merge into one or more common fuel exhaust conduits that transport exhaust fuel from each individual fuel cell to one or more common fuel purge modules 110. Alternatively, the fuel cell stack assembly may include individual fuel purge modules that are each in fluid communication with individual fuel purge conduits 96.

Similarly, a fuel cell stack assembly that includes more than one fuel cell 20 may include a corresponding number of oxidizer exhaust conduits 100 that each transport exhaust oxidizer from each individual fuel cell. Exhaust assembly 82 may include any suitable number of fuel purge conduits 96, oxidizer exhaust conduits 100, and combined exhaust conduits 108 to provide sufficient exhaust flow from the fuel cell stack assembly. Moreover, fuel purge conduits 96 and oxidizer exhaust conduits 100 may join (i.e., be fluidly connected) at any suitable location to form combined exhaust conduits 108. Alternatively, fuel purge conduits 96 and oxidizer exhaust conduits 100 may each be in fluid communication directly with stack exhaust 94 without the use of a combined exhaust conduit 108.

Control system 84 may include one or more analog or digital circuits, logic units, or processors for operating programs stored as software in memory, and may include one or more distinct units in communication with each other. The illustrative, non-exclusive example shown in FIG. 2 includes a system controller 118, one or more system sensors 120 that may include one or more current sensors 122, and a plurality of communication linkages 124. System controller 118 may communicate with the several components of fuel cell system 80 via communication linkages 124. For example, the system controller may communicate with fuel source 52 via a fuel source communication linkage 126, with oxidant source 54 via an oxidant source communication linkage 128, with fuel purge module 110 via a fuel purge communication linkage 130, and with current sensor 122 via a current sensor communication linkage 132. Other linkages 124 may be used, such as linkages to system sensors 120 monitoring components within stack exhaust 94, load 70, or other components of fuel cell system 80.

Communication linkages 124 may enable at least one-way communication with the system controller. In some cases, communication linkages may transport communication signals 134 that represent measured values that may indicate the operating state of fuel cell system 80 to control system 84. Illustrative examples of values that may be monitored by the control system include current or voltages produced by one or more fuel cells, gas delivery pressures or flow rates, temperatures, and the like. Additionally or alternatively, communication signals 134 may represent command signals 136 from system controller 118 to the various components of the fuel cell system. Some communication linkages 124 may transport both communication signals and command signals.

Communication linkages 124 may be adapted to transport, or relay, signals that may be either analog or digital in nature. The linkages may transport signals via wired and/or wireless electromagnetic communication methods, including radio-frequency (RF), infrared (IR), or light transmission, via pneumatic and/or hydraulic methods, or via combinations of these.

As discussed previously in reference to FIG. 1, oxidant 46 may be supplied to the fuel cell stack assembly with dilutant 58 as oxidizer 56. In the example illustrated in FIG. 2, the oxidizer, embodied by air 62, may be provided at a supply oxidizer flow rate. Similarly, the primary components of the oxidizer, specifically oxygen gas and nitrogen gas, may be provided at a supply oxidant flow rate and at a supply dilutant flow rate that has a predetermined (or essentially fixed) ratio to the supply oxidant flow rate. During operation of fuel cell system 80, fuel cell stack assembly 24 may be adapted to consume a portion of supply fuel 44 and supply oxidant 46 in order produce an electric current therefrom. Exhaust oxidant 104 may include a difference between supply oxidant 46 and the consumed portion of the supply oxidant. Accordingly, exhaust oxidizer 102 may include exhaust oxidant 104 and exhaust dilutant 106. Exhaust dilutant 106 may be transported from cathode region 32 at an exhaust dilutant flow rate that may correspond to the supply dilutant flow rate.

As is known in the fuel cell system art, anode region 30 of an operating fuel cell needs to be purged to remove fuel impurities, nitrogen, water, and the like, which, if left in place in the anode region, would degrade fuel cell performance. Accordingly, fuel and other gases may be purged from the anode region, either on an intermittent or continuous basis. As has been discussed previously, fuel purge module 110, or more particularly, solenoid valve 114 of FIG. 2, may be adapted to intermittently release gas, including a released volume of exhaust fuel, from anode region 30 to exhaust fuel purge conduit 96. System controller 118 may be adapted to generate one or more command signals 136, which may include fuel purge command signals 112 to selectively actuate fuel purge module 110. In order to determine when to generate the fuel purge command signals, the system controller may employ one or more of a number of algorithms, which may include various methods that monitor one or more aspects of the performance of fuel cell stack assembly operation, fuel cell system operation, and/or the flammability of the exhaust stream of the fuel cell system.

A fuel cell system having supply streams of hydrogen gas and air may have exhaust streams that include hydrogen gas, oxygen gas, nitrogen gas, and water, as well as several other components of the atmosphere that may be included with the supply air, such as argon gas and carbon dioxide gas, which, for the purposes of fuel cell operation, may be considered impurities. The components of the supply and the exhaust streams may be expressed as ratios, in equation form, by the expression

(2+α)H₂+λO₂+3.71*λN₂→2H₂O+αH₂+(λ−1)O₂+3.71*λN₂

In this expression, λ represents an excess oxygen ratio that is a ratio of the amount of oxygen gas supplied to the fuel cell stack assembly to the minimum amount of oxygen gas required to react with the consumed hydrogen gas, or other fuel. The 3.71 multiplicative factor corresponds to the nitrogen gas in both the supply and the exhaust, and relates to the relative concentration of nitrogen gas to oxygen gas in atmospheric air. In the expression, α represents an optional excess amount of fuel supplied to fuel cell stack assembly 24 in excess of the portion that is consumed to produce electric current. An excess hydrogen ratio θ is frequently used in place of the excess amount of fuel supplied to the fuel cell stack assembly, and may be defined by the illustrative (non-exclusive) expression 0=(2+α)/2. The excess hydrogen ratio θ may represent the ratio of the amount of supplied fuel to the portion of the supplied fuel that is consumed.

Any value of the excess hydrogen ratio θ greater than 1.0 implies that fuel cell system 22 exhausts some amount, or flow, of hydrogen gas to its surroundings. According to the present disclosure, it is desirable that the exhaust be sufficiently diluted prior to release to the surroundings so that the exhaust stream is not flammable upon its release. This determination may be satisfied on an instantaneous and/or time-averaged basis. Under the operating conditions of many fuel cell systems, water may exist as either a vapor or as a liquid. Accordingly, the presence of water in the exhaust stream may be neglected, or disregarded, for the purposes of exhaust flammability determination. Any amounts of water that are present in the exhaust gases of the fuel cell stack assembly will add to the margin of flammability, as the water vapor will serve as a further dilutant in the exhaust stream.

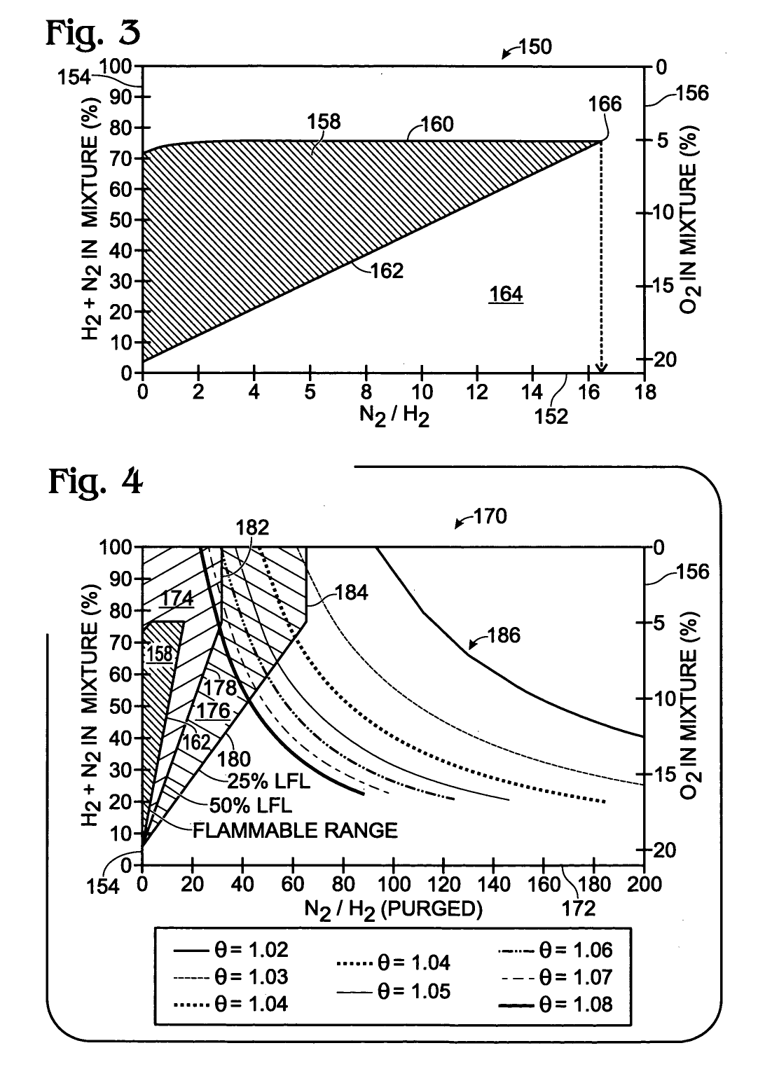

FIG. 3 depicts a graph 150 showing the flammability envelope of mixtures of hydrogen gas and nitrogen gas exhausted into air. Horizontal axis 152 of graph 150 represents the ratio of the concentration of nitrogen gas to the time-weighted concentration of hydrogen gas in the exhaust. Vertical axis 154 represents the amount of the released exhaust gas mixture that represents the exhausted nitrogen gas/hydrogen gas relative to the surrounding air, on a percentage (volume or molar) basis. It is of note that the nitrogen gas in the surrounding air is not represented in the value plotted on vertical axis 154. Alternate vertical axis 156, accordingly, represents the amount, on a percentage basis, of the released exhaust gas mixture that represents the oxygen gas concentration. Accordingly, zero percent exhausted nitrogen gas/hydrogen gas mixture corresponds to the standard 21% (by volume) of oxygen gas found in air.

Graph 150 includes a region 158 that represents the region in which an exhausted mixture of nitrogen gas and hydrogen gas is flammable in air. Flammability region 158 includes an upper boundary 160 above which the concentration of the hydrogen gas in the final gas mixture exceeds the upper flammability limit (UFL). This would not be a desired operating point for any fuel cell system, because ultimately the gas mixture will be further diluted by air, and the resulting final dilution will fall into flammability region 158.

Flammability region 158 also includes a lower boundary 162, below which the concentration of hydrogen gas in the final gas mixture is below the lower flammability limit (LFL). As shown in FIG. 3, the lower boundary represents a linear relationship of the amount of the final gas mixture that represents the exhausted nitrogen gas/hydrogen gas relative to the surrounding air on vertical axis 154 with the ratio of the concentration of nitrogen gas to the concentration of hydrogen gas in the exhaust represented on horizontal axis 152. The area of graph 150 below lower boundary 162 represents a non-flammable regime of operation 164, as any mixture within this regime does not require further dilution by the ambient air to become non-flammable.

The intersection of upper boundary 160 with lower boundary 162 represents a critical dilution point 166 above which no mixture can be flammable. As shown in FIG. 3, critical dilution point 166 corresponds to a critical ratio (CR) of the concentration of nitrogen gas to the concentration of hydrogen gas in the exhaust CR=16.5. At ratios above this CR, no mixture of hydrogen gas and nitrogen gas is flammable when released into air.

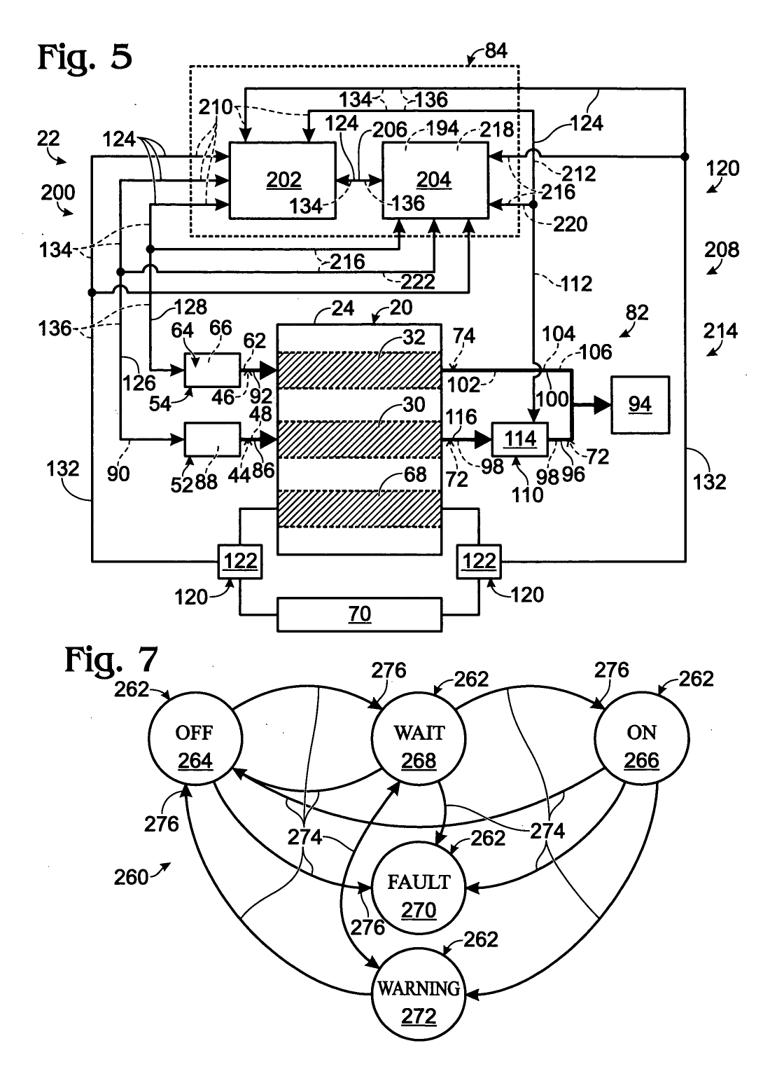

Turning now to FIG. 4, a graph 170 that includes flammability region 158 is shown in the context of the operation of a fuel cell system, such as a fuel cell system 22 or 80 according to the present disclosure. Graph 170 includes a horizontal axis 172 that is similar to horizontal axis 152 of graph 150, but with an expanded range to include operating points of an exemplary fuel cell system. Graph 170 includes the same vertical axis 154 and alternative vertical axis 156 as graph 150. In the context of fuel cell system 80, vertical axis 154 represents the sum of the dilutant flow, specifically nitrogen gas, through the cathode region 32 and the average fuel flow, specifically hydrogen gas, that is released by fuel purge module 110.

In addition to flammability region 158, graph 170 also includes illustrative examples of flammability limits, or thresholds, namely, a 50% flammability region 174 and a 25% flammability region 176. Regions 174 and 176 represent the region in which the exhausted nitrogen gas/hydrogen gas mixture exceeds 50% of the LFL and 25% of the LFL of hydrogen, respectively. The 50% flammability region and the 25% flammability region, like flammability region 158, each include a lower boundary, which is indicated at 178 and 180, respectively. Instead of an upper boundary, 50% flammability region 174 and 25% flammability region 176 each include a vertical boundary 182 and 184. The vertical boundaries represent a ratio of exhausted nitrogen gas to exhausted hydrogen gas that exceeds the 50% flammability limit and the 25% flammability limit of hydrogen, respectively. As can be seen in FIG. 3 and can be calculated, 50% vertical boundary 182 corresponds to a CR_{50%LFL} of CR multiplied by 2, or 33.0, and 25% vertical boundary 184 corresponds to a CR_{25%LFL} of CR multiplied by 4, or 66.0. It should be understood that the 50% and 25% flammability thresholds have been provided as illustrative, non-exclusive examples. It is within the scope of the present disclosure that the control systems and methods may be configured responsive to these or other selected flammability thresholds, including thresholds that are greater than, less than, or between these illustrative thresholds, or limits.

The excess oxygen ratio λ can be translated onto alternative vertical axis 156. 0.0% oxygen content in the exhaust stream corresponds to an excess oxygen ratio λ=1.0. Increasing the oxygen content in the exhaust stream may correspond to higher excess oxygen ratio λ. For example, an excess oxygen ratio λ=2.0 may correspond to 9.9% oxygen gas content, and an excess oxygen ratio λ=4.0 may correspond to 17.1% oxygen gas content.

Graph 170 also includes a plurality of curves 186 that represent the characteristics of an illustrative fuel cell system operating at various excess hydrogen ratios ranging from 0=1.02 to 0=1.08. Lower excess hydrogen ratios θ correspond to curves 186 that lie further from flammability regions 158, 174, and 176, because less hydrogen gas is exhausted from the fuel cell system relative to the amount of nitrogen gas that is exhausted. Curves corresponding to excess hydrogen ratios θ that do not intersect flammability regions 158, 174, and 176 correspond to operating points of the fuel cell system which exceed those flammability limits for any excess oxygen ratio λ.

A target for the excess fuel ratio θ may be determined to guarantee non-flammability of the exhaust stream of fuel cell system 80. Calculation of the target excess fuel ratio θ may require several assumptions. First, a minimum oxidant flow may be present, corresponding to the presence of a minimum dilutant flow and an excess oxygen ratio λ=1.0. Second, assumption of a specific non-flammability limit must be made. As an illustrative, non-exclusive example, one may be interested to determine the excess fuel ratio θ to operate fuel cell system 22 outside 50% flammability region 174, outside 25% flammability region 176, or at or within any of the other flammability thresholds or regions provided for herein. As shown in FIG. 3, the point where vertical boundary 182 of 50% flammability region 174 intersects the top of graph 170, which corresponds to excess oxygen ratio λ=1.0, lies between the curves corresponding to excess fuel ratio θ=1.05 and θ=1.06. In other examples, it may be desirable to operate fuel cell system 80 outside 25% flammability region 176, or some other suitable operating regime.

One may specifically calculate the excess fuel ratio θ_{50%LFL} corresponding to the excess fuel ratio θ curve that intersects vertical boundary 182 of the 50% flammability region. The ratio of the exhaust dilutant flow rate to the average flow rate of released fuel, as can be deduced from the expression of fuel cell system supply and exhaust components presented earlier, can be expressed as 3.71/α. Through the interrelationship of the excess amount of supply fuel a to the excess fuel ratio θ, this expression may be rewritten as 3.71/(2*θ−2). If one wishes to determine the target θ_{50%LFL}, this corresponds to the ratio being equal to CR_{50%LFL}=30.0. Accordingly, θ_{50%LFL} may be calculated as 1.056.

Referring again to FIG. 2, fuel cell systems 22 according to the present disclosure, including fuel cell systems 80, may include, within system controller 118, a fuel purge control system 190 that includes a fuel purge controller 192 that may be adapted to determine a maximum exhaust fuel flow rate and to determine a fuel dilution factor. The fuel purge controller may be adapted to calculate the fuel dilution factor as a ratio of the released volume of exhaust fuel 98 to the released volume of the exhaust dilutant 106. The fuel purge controller may include an available dilutant module 194 that is adapted to receive, such as via communication linkages 124, inputs from various system sensors 120 that indicate the released volume of exhaust dilutant, such as flow sensors in air conduit 92 or exhaust oxidizer conduit 100, or the like.

Available dilutant module 194 may receive other inputs that directly or indirectly provide for or otherwise permit the calculation of a minimum flow rate of the dilutant through the fuel cell stack assembly. Specifically, since the ratio of the flow rate of both supply dilutant 58 and supply oxidant 46 is a value predetermined by the nature of atmospheric air, the fuel purge controller may calculate a minimum flow rate of dilutant if an indicator of a minimum flow rate of the oxidizer may be determined, with an assumption that the excess oxygen ratio λ=1.0. For any values of excess oxygen ratio λ>1.0, the actual exhaust dilutant flow will exceed this calculated minimum, adding to the margin of non-flammability.

As discussed, the fuel cell stack assembly consumes a portion of the supply oxidant 46 to produce an electric current. Accordingly, by measuring the electric current produced by the fuel cell stack assembly and with knowledge about the number of fuel cells comprising the fuel cell stack assembly, the fuel purge controller may calculate or otherwise store, receive, or determine a minimum supply oxidant flow rate, and, in turn, a minimum supply dilutant flow rate. Accordingly, the fuel purge control system may include one or more current sensors 122 that are adapted to generate a measurement of the electric current produced by the fuel cell stack assembly, which may be provided to available dilutant module 194 as one or more communication signals 134.

Fuel purge controller 192 may generate fuel purge command signals 112 in order to control the exhaust fuel flow rate such that the fuel dilution ratio is maintained below a threshold value, which may be a predetermined value, a calculated value, or both. In examples where fuel is exhausted intermittently, the fuel purge controller may be adapted to determine a maximum time-averaged exhaust fuel flow rate and to determine a time-averaged fuel dilution factor that is a ratio of the time-averaged released volume of the exhaust fuel to the time-averaged released volume of the exhaust dilutant at the minimum exhaust dilutant flow rate. In these illustrative examples, the fuel purge controller may be adapted to generate the fuel purge command signals in order to control the time-averaged exhaust fuel flow rate such that the fuel dilution ratio is maintained below a predetermined value.

In some examples, fuel purge controller 192 may be adapted to maintain the fuel dilution factor below the lower flammability limit (LFL) of the fuel. In some of these examples, the fuel purge controller may be adapted to maintain the fuel dilution factor at a fraction (i.e., less than 100%) of the lower flammability limit of the fuel, such as below 90% of the LFL, below 75% of the LFL, below 50% of the LFL, below 25% of the LFL, or below 10% of the LFL.

For example, consider a fuel cell stack assembly 24 that consumes 0.003676 SLPM (standard liter per minute) of oxygen gas for each ampere of electric current produced, and for each individual fuel cell 20 in a series-implementation of fuel cells. An exemplary fuel cell system operating to produce an exhaust stream that contains less than 50% of the lower flammability limit of the fuel may include 24 individual fuel cells connected in series and producing an electric current of 34 amperes. The available dilutant module of this exemplary fuel cell system may determine that the fuel cell system is operating at a minimum nitrogen flow rate of 11.13 SLPM. Fuel purge controller 192 may be adapted to generate fuel purge command signals 112 in order to control the exhaust fuel flow rate such that the fuel dilution ratio based upon the minimum determined dilutant flow rate is maintained below 50% of the LFL of hydrogen gas.

In examples of fuel cell system 80 in which fuel is exhausted intermittently, fuel purge controller 192 may be adapted to determine at least one of a duration of time and a frequency that fuel purge module 110, such as may include solenoid valve 114, may be actuated to transition into, and remain in the open configuration. The fuel purge controller may determine a duty cycle, which may be defined as a ratio of the time that the fuel purge module is in the open configuration to the total time. If fuel source 52 is adapted to provide hydrogen gas to anode region 30 at a constant pressure, fuel purge controller 192 may be adapted to use the duty cycle to calculate the exhaust fuel flow rate, or the time-averaged exhaust fuel flow rate in order to calculate the fuel dilution ratio. The duty cycle can also be used to calculate the excess fuel ratio θ of the operating point of the fuel cell system. Accordingly, curves 186 on graph 170 of FIG. 4 may be relabeled with appropriately calculated duty cycles that correspond to current outputs of the fuel cell system. Curves corresponding to higher values of excess fuel ratios θ may correspond to lower duty cycles and/or lower electrical currents produced by the fuel cell stack assembly. Accordingly, it can be deduced that fuel cell systems that are producing low levels of electric current operate in regimes where they are at more of a risk to release flammable exhaust.

Fuel cell system 80 shown in FIG. 2 may be considered to utilize an active control system. Control system 84, as has been described, may be adapted to actively control the purging of gases from anode region 30 in order to maintain non-flammable exhaust characteristics. FIG. 5 shows a second illustrative example 200 of fuel cell system 22 that employs a second exhaust control strategy, or method, to maintain non-flammable exhaust characteristics. Like fuel cell system 80 described previously, fuel cell system 200 may include fuel cell stack assembly 24, fuel source 52, oxidant source 54, exhaust assembly 82, and control system 84. Fuel cell system 200 may be in communication with a load 70. Control system 84, in this example, may include at least one functional controller 202 and interlock controller 204 that each may be adapted to communicate with the several components of fuel cell system 200 via communication linkages 124. Control system 84 may also include an inter-controller linkage 206 that is adapted to transport communication signals 134 and or command signals 136 between the functional controller and the interlock controller.

Functional controller 202 may be adapted to monitor performance of fuel cell stack assembly 24. The functional controller may receive communication signals 134 from system sensors 120, such as current sensor 122 and system sensors located within fuel source 52, oxidant source 54, fuel purge module 110, load 70, and the like. The functional controller may be adapted to maintain performance of fuel cell stack assembly 24 by selectively generating at least one command signal 136 to selectively actuate one or more control inputs 208. Accordingly, command signals 136 that may be generated by functional controller 202 may be designated as functional command signals 210. In particular, fuel purge command signals 112 that may be generated by functional controller 202 may be designated as functional controller fuel purge command signals 212. Other control inputs 208 that may be actuated may include inputs located within fuel source 52, oxidant source 54, fuel purge module 110, load 70, and so forth. Illustrative, non-exclusive examples of functional controllers and control methods are disclosed in U.S. Pat. Nos. 6,495,277, 6,383,670, and 6,451,464, the complete disclosures of which are hereby incorporated by reference.

Interlock controller 204, like functional controller 202, may be adapted to monitor performance of fuel cell stack assembly 24. The interlock controller may receive communication signals 134 from system sensors 120, such as current sensor 122 and other system sensors such as system sensors located within fuel source 52, oxidant source 54, fuel purge module 110, load 70, functional controller 202, and the like. Interlock controller 204 may be adapted to ensure that fuel cell stack assembly 24 operates in a regime that is not harmful to either fuel cell system 200 or its surroundings, such as creating excess heat, releasing exhaust streams that may include reactive, toxic, and/or flammable gas mixtures, and the like. Accordingly, interlock controller 204 may be adapted to detect one or more operating conditions that may be a precursor to a harmful condition, and to generate one or more command signals 136 that may be adapted to ensure that the operating condition of fuel cell stack assembly 24 does not degrade, by actuating one or more interlock elements 214. Command signals generated by interlock controller 204 to actuate one or more interlock elements may be designated as interlock command signals 216.

Interlock controller 204 may include an available dilutant module 194 and a fuel purge interlock controller 218. Available dilutant module 194 of interlock controller 204 may operate like available dilutant module 194 of fuel purge control system 190 to determine the consumed portion of the supply oxidant and the corresponding minimum exhaust dilutant flow rate, based upon a measurement of the electric current produced by fuel cell stack assembly 24. Fuel purge interlock controller 218 may be adapted to determine a fuel dilution factor and to generate a fuel purge command signal 112 to actuate fuel purge module 110, such as solenoid valve 114, to transition to the closed configuration when the fuel dilution factor exceeds a predetermined value, which may be preselected or determined by the control system. A fuel purge command signal 112 that is generated by fuel purge interlock controller 218 may be designated as an interlock fuel purge command signal 220.

It is within the scope of the present disclosure that the various controllers, modules, linkages, sensors, and the like of control system 84 may be implemented in any suitable configuration and with any suitable components and/or mechanism. In some embodiments, one or more of these components of control system 84 may be implemented together, while in others they may be implemented as separate components that are cooperatively in communication with each other, such as provided for herein.

Both exhaust oxidizer 102 and exhaust fuel 98 may be emitted from fuel cell system 200, as was the case with fuel cell system 80, intermittently or continuously. In examples in which exhaust oxidizer 102 and exhaust fuel 98 is emitted intermittently, the flow rate of the exhausts may be considered on a time-averaged basis. In these illustrative embodiments, the flow of exhaust oxidizer or exhaust fuel may be considered to be continuous even though the physical cathode discharge 74 or anode discharge 72 may only be intermittent. Accordingly, at least one of functional controller 202 and interlock controller 204 may be adapted to detect or determine a time-averaged exhaust oxidizer or exhaust fuel flow rates. The timing between intermittent purges and the duration of each purge may be fixed or may be determined by functional controller 202, as has been discussed previously.

Fuel purge module 110 may include one or more elements that may be adapted to be selectively actuated, in response to either functional controller fuel purge command signal 212 or interlock fuel purge command signal 220, to modulate a volume of exhaust fuel 98 that may be released into fuel purge conduit 96 and, in turn, to stack exhaust 94. In examples of fuel cell system 200 in which fuel is exhausted intermittently, fuel purge module 110 may be adapted to be selectively actuated, in response to either fuel purge command signal, to transition between a closed configuration, in which the fuel purge module is adapted to prevent exhaust fuel from being introduced or released into the stack exhaust, and an open configuration, in which the fuel purge module is adapted to release a volume of exhaust fuel 98 into the fuel purge conduit 96 and, in turn, to stack exhaust 94. A non-exclusive example of fuel purge module 110 that is adapted to emit exhaust fuel 98 intermittently may include solenoid valve 114.

In examples of fuel cell system 200 in which fuel is exhausted continuously, fuel purge module 110 may be adapted to be selectively actuated, in response to the functional controller fuel purge command signal, to regulate a volume of exhaust fuel 98 that may be released into the fuel purge conduit 96 and, in turn, to stack exhaust 94. More particularly, fuel purge module 110 may be adapted to emit a continuous, modulating stream of exhaust fuel. In these examples, fuel purge module 110 may also be adapted to be selectively actuated, in response to the interlock fuel purge command signal, to transition between an open configuration, in which the fuel purge element is adapted to regulate the volume of exhaust fuel in response to the functional controller fuel purge command signals, and a closed configuration, in which the fuel purge element is adapted to prevent exhaust fuel from entering the stack exhaust regardless of any functional controller fuel purge command signals. A non-exclusive example of fuel purge module 110 that is adapted to emit a continuously modulating stream of exhaust fuel may include an orifice-adjusting valve or the like. Fuel purge module 110 may also include a combination of these elements, or a single element that performs a combination of these functions to intermittently emit a modulating and interruptible stream of exhaust gases.

The fuel dilution factor may be a ratio of the released volume of exhaust fuel to the released volume of the exhaust dilutant at the minimum exhaust dilutant flow rate. In some examples, the fuel dilution factor may be at a fuel dilution factor that is a ratio of the time-averaged released volume of exhaust fuel to the time-averaged released volume of exhaust dilutant at the minimum exhaust dilutant flow rate.

In some examples, interlock controller 204 may generate interlock fuel purge command signals 220 to actuate fuel purge module 110 to transition to the closed configuration when the fuel dilution factor exceeds the lower flammability limit (LFL) of the fuel. Alternatively, interlock controller 204 may generate interlock fuel purge command signals 220 to actuate fuel purge module 110 to transition to the closed configuration when the fuel dilution factor exceeds a fraction of the lower flammability limit (LFL) of the fuel, such as any of the previously discussed illustrative thresholds, including 50%, 25%, or 10%.

In some embodiments of fuel cell system 200, interlock controller 204 may be configured to generate interlock fuel purge command signals 220 to actuate fuel purge module 110 to transition to the closed configuration upon the detection of other conditions within the fuel cell system. For example, in order to prevent periods of the release of flammable exhaust streams, the interlock controller may be adapted to generate the interlock fuel purge command signals when functional controller fuel purge command signal 212 to actuate the fuel purge module to transition to the closed configuration has not been generated for more than a predetermined duration of time.

Interlock controller 204 may be adapted to generate interlock command signals 216 that are adapted to actuate one or more interlock elements 214. For example, fuel source 52 may include fuel source cutoff module 88 that may be adapted to be actuated in response to fuel source cutoff command signal 90. Interlock controller 204 may be adapted to generate an interlock fuel source cutoff command signal 222 to actuate the fuel source cutoff module to transition to the closed configuration when the interlock fuel purge command signal 220 is generated to actuate the fuel purge module to the closed configuration.

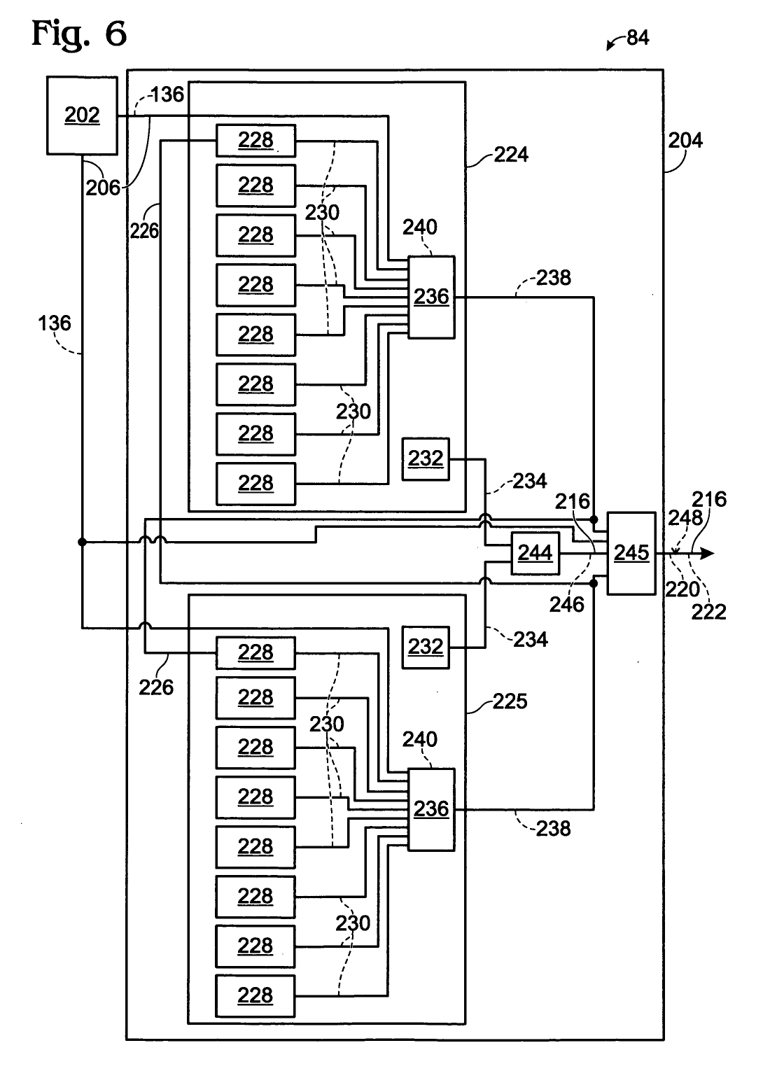

An illustrative, non-exclusive example of a suitable configuration for control system 84 of fuel cell system 200, and more particularly, interlock controller 204, is shown in greater detail in FIG. 6. As illustrated, interlock controller 204 includes a first interlock processor 224 and a second interlock processor 225. The first and second interlock processors may be adapted to communicate with functional controller 202 via inter-controller communication linkages 206, and with each other via inter-interlock controller communication linkage 226.

Interlock processors 224 and 225 may include a plurality of interlock circuits 228 that are adapted to receive communication signals 134 from one or more system sensors 120, which may include one or more current sensors 122 or other components within fuel source 52, oxidant source 54, fuel purge module 110, stack exhaust 94, load 70, or other components of fuel cell system 200, and to generate an interlock output 230. Specifically, in addition to interlock outputs that relate to amounts of fuel emitted in the exhaust stream of the fuel cell stack assembly, interlock outputs may relate to conditions such as fuel supply pressure, ventilation and/or temperatures within any enclosures contained within fuel cell system 200, and temperatures of and/or coolant flows within fuel cell stack assembly 24. Interlock processors 224 and 225 may also each include an interlock fault generator 232 that is adapted to generate a fault command signal 234 if a malfunction is detected within the interlock processor.

Each interlock processor may include one or more interlock logic circuits 236 that may be adapted to process one or more interlock outputs in order to determine one or more interlock states that may be output as an interlock status signal 238. A non-exclusive example of interlock logic circuit 236 may be a multi-port AND logic gate 240 that may be adapted to perform a Boolean AND process on the combination of interlock outputs 230 to provide an interlock status signal 238. Control system 84 may also include additional logic processors 244 and 245 that are adapted to perform additional logic functions using outputs of interlock processors 224 and/or 225, to generate at least one interlock command signal 216.

For example, FIG. 6 shows two additional logic processors 244 and 245. In one non-exclusive example, additional logic processor 244 may include a Boolean AND gate that may be adapted to receive interlock fault command signals 234, and to generate an interlock fault output 246. In another non-exclusive example, additional logic processor 245 may include a Boolean AND gate that may be adapted to receive one or more interlock status signals 238, which may include interlock fault output 246 as well as one or more command signals 136 from functional controller 202. System controller 84 may generate an interlock status command signal 248 that may include interlock fuel purge command signal 220 and/or interlock fuel source cutoff command signal 222.

Turning now to FIG. 7, an illustrative, non-exclusive example of a state diagram 260 for the operation of an example of fuel cell system 200 is shown. State diagram 260 includes a plurality of operational states 262 of system controller 84. Operational states 262 may include an OFF state 264 in which fuel cell system 200 is not producing electric current, but various subsystems are ready to enter ON state 266. For example, fuel source 52 may be available to provide supply fuel 44, and/or oxidant source 54 may be available to provide supply oxidant 46.

Prior to entering ON state 266, system controller 84 may enter a WAIT state 268 for a predetermined period of time, such as for sixty seconds, to ensure that the entirety of fuel cell system 200 is ready to produce electric current. After the predetermined period of time has elapsed, the operation of fuel cell system 200 may enter ON state 266. Alternatively, if any faults are detected while operating in WAIT state 268, operation may return to OFF state 264, or may proceed to a FAULT state 270, in which one or more command signals 136 may be generated to actuate one or more interlock elements 214. Additionally, the detection of any faults during operation in ON state 266 may indicate that fuel cell system 200 may be operating in a regime that may be harmful to the fuel cell system or its surroundings. For example, the generation of interlock status command signal 248 may cause the operation of the fuel cell system to enter FAULT state 270.

Once the operation of fuel cell system 200 has entered FAULT state 270, functional controller 202 may be prevented from generating functional command signals 210 that may be adapted to actuate one or more control inputs 208 until some user interactions with fuel cell system 200 are performed. User interactions may include moving the operation of the fuel cell system to OFF state 264. As a non-exclusive example, upon detection of the generation of the interlock fuel purge command signal, the control system may enter WAIT state 268 and may be adapted to prevent the generation of functional controller fuel purge command signal 212 and the like.

State diagram 260 also includes a WARNING state 272, which like FAULT state 270, may be entered upon detection of specific conditions while operating in OFF state 264 or ON state 266. However the conditions that may trigger the entrance of WARNING state 272 may not be as serious as conditions that may trigger the entrance of FAULT state 270. For example, the detection of a low temperature within an enclosure of fuel cell stack assembly 24 may cause control system 84 to enter WARNING state 272. In the WARNING state, like in the FAULT state, one or more command signals 136 may be generated to actuate one or more interlock elements 214 and the fuel cell stack assembly ceases the generation of electric current. Alternatively, the fuel cell stack assembly may continue to generate electric current, but an operator may be alerted to the presence of the condition that triggered the WARNING state. Upon detection of the disappearance of the conditions that triggered the WARNING state, operation of control system 84 may remain in WARNING state 272, or alternatively, operation may return to ON state 266.

State diagram 260 includes a plurality of state transition arrows 274 that may indicate valid state transitions, such as the several transitions discussed previously. These state transitions may allow transitions between states 262 in one direction or in both directions, as indicated by arrowheads 276. In addition to the state transitions discussed previously, FIG. 7 shows a state transition arrow 274 indicating a state transition between ON state 266 and OFF state 264 that may allow a user to stop the production of electric current from fuel cell system 200. Additionally or alternatively, FIG. 7 shows state transitions to and from WARNING state 272.

The automation of fuel cell system 22 enables it to be used in households, vehicles and other commercial applications where the system is used by individuals that are not trained in the operation of fuel cell systems. It also enables use in environments where technicians, or even other individuals, are not normally present, such as in microwave relay stations, unmanned transmitters or monitoring equipment, etc. Control system 84 also enables the fuel cell system to be implemented in commercial devices where it is impracticable for an individual to be constantly monitoring the operation of the system. For example, implementation of fuel cell systems in vehicles and boats requires that the user does not have to continuously monitor and be ready to adjust the operation of the fuel cell system. Instead, the user is able to rely upon the control system to regulate the operation of the fuel cell system, with the user only requiring notification if the system encounters operating parameters and/or conditions outside of the control system's range of automated responses.

The above examples illustrate possible applications of such an automated fuel cell system, without precluding other applications or requiring that a fuel cell system necessarily be adapted to be used in any particular application. Furthermore, in the preceding paragraphs, control system 84 has been described controlling various portions of the fuel cell system. The system may be implemented without including every aspect of the control system described above. Similarly, system 22 may be adapted to monitor and control operating parameters not discussed herein and may send command signals other than those provided in the preceding examples.

### INDUSTRIAL APPLICABILITY

Fuel cell systems and control systems described herein are applicable in any situation where power is to be produced by a fuel cell stack assembly. It is particularly applicable when the fuel cell stack assembly emits flammable exhaust gases to the surroundings of the fuel cell system.

It is believed that the disclosure set forth above encompasses multiple distinct methods and/or apparatus with independent utility. While each of these methods and apparatus has been disclosed in its preferred form, the specific examples thereof as disclosed and illustrated herein are not to be considered in a limiting sense as numerous variations are possible. The subject matter of the disclosures includes all novel and non-obvious combinations and subcombinations of the various elements, features, functions and/or properties disclosed herein. Similarly, where the claims recite “a” or “a first” element or the equivalent thereof, such claims should be understood to include incorporation of one or more such elements, neither requiring nor excluding two or more such elements.

It is believed that the following claims particularly point out certain combinations and subcombinations that correspond to disclosed examples and are novel and non-obvious. Other combinations and subcombinations of features, functions, elements and/or properties may be claimed through amendment of the present claims or presentation of new claims in this or a related application. Such amended or new claims, whether they are directed to different combinations or directed to the same combinations, whether different, broader, narrower or equal in scope to the original claims, are also regarded as included within the subject matter of the present disclosure.

1. A fuel cell system, comprising:
a fuel cell stack assembly, comprising:
at least one fuel cell having an anode region and a cathode region; and
a fuel purge module adapted to selectively purge the anode region of the at least one fuel cell;
wherein the fuel cell stack assembly is adapted to receive a supply fuel and a supply oxidizer that comprises a supply oxidant and a supply dilutant;
wherein the fuel cell stack assembly is further adapted to consume a portion of the supply fuel and a portion of the supply oxidant to produce an electric current therefrom;
an exhaust assembly, comprising:
a stack exhaust in fluid communication with the fuel purge module;
a fuel exhaust conduit in fluid communication with the fuel purge module and adapted to transport an exhaust fuel away from the fuel cell stack assembly; and
an oxidizer exhaust conduit in fluid communication with the stack exhaust and adapted to transport an exhaust oxidizer from the fuel cell stack assembly, wherein the exhaust oxidizer comprises an exhaust dilutant and an exhaust oxidant; and
wherein the fuel purge module is adapted to be selectively actuated, in response to a fuel purge command signal, to regulate a volume of the exhaust fuel that is released into the stack exhaust; and
a fuel purge control system, comprising:
a current sensor adapted to generate a measurement of the electric current produced by the fuel cell stack assembly;
an available dilutant module in electrical communication with the current sensor and adapted to determine a consumed portion of the supply oxidant and a corresponding minimum exhaust dilutant flow rate based upon the measurement of the electric current produced by the fuel cell stack assembly; and
a fuel purge controller adapted to determine a maximum exhaust fuel flow rate and to determine a fuel dilution factor, the fuel dilution factor being a ratio of the released volume of the exhaust fuel to a released volume of the exhaust dilutant at the minimum exhaust dilutant flow rate, the fuel purge controller being further adapted to generate the fuel purge command signals to control the exhaust fuel flow rate such that the fuel dilution factor is maintained below a threshold value.

2. The fuel cell system of claim 1, wherein the fuel purge controller is adapted to determine a maximum time-averaged exhaust fuel flow rate and to determine a time-averaged fuel dilution factor, the fuel dilution factor being a ratio of the time-averaged released volume of the exhaust fuel to the time-averaged released volume of the exhaust dilutant at the minimum exhaust dilutant flow rate, the fuel purge controller being further adapted to generate the fuel purge command signals to control the time-averaged exhaust fuel flow rate such that the fuel dilution factor is maintained below the threshold value, and further wherein the fuel purge module is adapted to be selectively transitioned between an open configuration, in which the fuel purge module is adapted to release a volume of the exhaust fuel into the stack exhaust, and a closed configuration, in which the fuel purge module is adapted to prevent the exhaust fuel from being released into the stack exhaust.

3. The fuel cell system of claim 2, wherein the fuel purge controller is adapted to determine at least one of a duration of time and a frequency that the fuel purge module may be in the open configuration.

4. The fuel cell system of claim 1, wherein the fuel has a lower flammability limit, and further wherein the fuel purge control system is adapted to maintain the fuel dilution factor below the lower flammability limit of the fuel.

5. The fuel cell system of claim 4, wherein the threshold value is at most 50% of the lower flammability limit of the fuel.

6. The fuel cell system of claim 1, wherein the exhaust oxidant comprises a difference between the supply oxidant and the consumed portion of the supply oxidant, wherein the exhaust dilutant is transported from the fuel cell stack assembly at an exhaust dilutant flow rate, wherein the supply dilutant is provided at a supply dilutant flow rate, and further wherein the exhaust dilutant flow rate corresponds to the supply dilutant flow rate.

7. The fuel cell system of claim 1, wherein the exhaust oxidizer is continuously emitted into the stack exhaust.

8. The fuel cell system of claim 1, wherein the supply fuel comprises hydrogen gas, wherein the supply oxidizer comprises air, wherein the supply oxidant comprises oxygen gas, and further wherein the supply dilutant comprises nitrogen gas.

9. The fuel cell system of claim 1 wherein the supply fuel is provided at a constant pressure.

10. The fuel cell system of claim 1, further comprising a fuel source comprising a fuel processor that is adapted to produce at least a portion of the supply fuel from at least one feedstock.

11. A fuel cell system, comprising:
a fuel cell stack assembly, comprising:
at least one fuel cell having an anode region and a cathode region; and
a fuel purge module adapted to selectively purge the anode region of the at least one fuel cell;
wherein the fuel cell stack assembly is adapted to receive a supply fuel and a supply oxidizer that comprises a supply oxidant and a supply dilutant;
wherein the fuel cell stack assembly is further adapted to consume a portion of the supply fuel and a portion of the supply oxidant to produce an electric current therefrom;
an exhaust assembly, comprising:
a stack exhaust in fluid communication with the fuel purge module;
a fuel exhaust conduit in fluid communication with the fuel purge module and adapted to transport an exhaust fuel away from the fuel cell stack assembly; and
an oxidizer exhaust conduit in fluid communication with the stack exhaust and adapted to transport an exhaust oxidizer away from the fuel cell stack assembly, wherein the exhaust oxidizer comprises an exhaust dilutant and an exhaust oxidant; and
wherein the fuel purge module is adapted to be selectively actuated, in response to at least one fuel purge command signal, to regulate a volume of the exhaust fuel that is released into the stack exhaust; the at least one fuel purge command signal comprising a functional controller fuel purge command signal and an interlock fuel purge command signal; and
a control system, comprising:
a current sensor adapted to generate a measurement of the electric current produced by the fuel cell stack assembly;
a functional controller adapted to monitor performance of the fuel cell stack assembly and to selectively generate one or more command signals comprising at least the functional controller fuel purge command signal; and
an interlock controller adapted to monitor performance of the fuel cell stack assembly and comprising:
an available dilutant module in electrical communication with the current sensor and adapted to determine a consumed portion of the supply oxidant and a corresponding minimum exhaust dilutant flow rate based upon the measurement of the electric current produced by the fuel cell stack assembly; and
a fuel purge interlock controller adapted to determine a fuel dilution factor, the fuel dilution factor being a ratio of the released volume of exhaust fuel to a released volume of the exhaust dilutant at the minimum exhaust dilutant flow rate, the fuel purge controller being further adapted to generate the interlock fuel purge command signal to actuate the fuel purge module to transition from an open configuration to a closed configuration, in which the fuel purge module is adapted to prevent exhaust fuel from being released into the stack exhaust, when the fuel dilution factor exceeds a threshold value.

12. The fuel cell system of claim 11, wherein the fuel purge controller is adapted to determine a time-averaged fuel dilution factor, the time-averaged fuel dilution factor being a ratio of the time-averaged released volume of exhaust fuel flow rate to the time-averaged released volume of the exhaust dilutant at the minimum exhaust dilutant flow rate, the fuel purge controller being further adapted to generate the interlock fuel purge command signal to actuate the fuel purge module to transition to the closed configuration when the time-averaged fuel dilution factor exceeds the threshold value.

13. The fuel cell system of claim 11, wherein the interlock controller is further adapted to generate the fuel purge command signal to actuate the fuel purge module to transition to the closed configuration when the functional controller fuel purge command signal to actuate the fuel purge module to transition to the closed configuration has not been generated for more than a predetermined duration of time.

14. The fuel cell system of claim 11, further comprising a fuel source and a fuel source cutoff module that is adapted to be selectively actuated, in response to a fuel source cutoff command signal, between an open configuration, in which the fuel source is adapted to provide the supply fuel to the fuel cell stack assembly, and a closed configuration, in which the fuel source cutoff module is adapted to prevent delivery of the supply fuel to the fuel cell stack assembly, wherein the interlock controller is further adapted to generate the fuel source cutoff command signal to actuate the fuel source cutoff module to transition to the closed configuration when the interlock fuel purge command signal to actuate the fuel purge module to transition to the closed configuration is generated.

15. The fuel cell system of claim 11, wherein the fuel has a lower flammability limit, and further wherein the threshold value is below the lower flammability limit of the fuel.

16. The fuel cell system of claim 11, wherein the control system comprises a plurality of the interlock controllers.

17. The fuel cell system of claim 11, wherein the control system is adapted to monitor the interlock fuel purge command signal, and is adapted, when the interlock controller generates the interlock fuel purge command signal to actuate the fuel purge module to transition to the closed configuration, to enter a control state in which the functional controller fuel purge command signal to actuate the fuel purge module to transition to the open configuration is not generated until specific user interactions with the fuel cell system are performed.

18. A method of operating a fuel cell stack assembly, the method comprising:
providing a supply fuel to the fuel cell stack assembly;
providing a supply oxidizer to the fuel cell stack assembly, the supply oxidizer comprising a supply dilutant and a supply oxidant;
consuming a portion of the supply fuel and a portion of the supply oxidant to produce an electric current therefrom;
generating a measurement of the electric current produced by the fuel cell stack assembly;
determining a consumption rate of the supply oxidant based upon the measurement of the electric current;
emitting an exhaust oxidizer to a stack exhaust, the exhaust oxidizer comprising an exhaust dilutant and an exhaust oxidant;
determining a minimum exhaust dilutant flow rate based upon the consumption rate of the supply oxidant;
determining an exhaust fuel flow rate;
determining a fuel dilution factor that is a ratio of the exhaust fuel flow rate to the minimum exhaust dilutant flow rate; and
generating a fuel purge command signal to control a fuel purge module to maintain the fuel dilution factor below a threshold value, wherein the fuel purge module is adapted to be selectively actuated, in response to the fuel purge command signal, to regulate a volume of the exhaust fuel that is released into the stack exhaust.

19. The method of claim 18, wherein determining an exhaust fuel flow rate comprises determining a time-averaged exhaust fuel flow rate.

20. The method of claim 19, wherein generating a fuel purge command signal comprises generating the fuel purge command signal to control the fuel purge module to maintain the fuel dilution factor below the threshold value, and further wherein the method includes selectively actuating the fuel purge module, in response to the fuel purge command signal, to be transitioned between an open configuration, in which the fuel purge module is adapted to release a volume of the exhaust fuel to the stack exhaust, and a closed configuration, in which the fuel purge module is adapted to prevent the exhaust fuel from being released into the stack exhaust.

21. The method of claim 20, wherein determining a time-averaged exhaust fuel flow rate comprises determining at least one of a duration of time and a frequency that the fuel purge command signals may actuate the fuel purge module to be transitioned to the open configuration.

22. The method of claim 18, wherein the fuel has a lower flammability limit and further wherein generating a fuel purge command signal comprises generating the fuel purge command signal to control the fuel purge module to maintain the fuel dilution factor below the lower flammability limit of the fuel.

23. The method of claim 18, wherein emitting an exhaust oxidizer comprises emitting an exhaust oxidizer that comprises an exhaust oxidant that comprises a difference between the supply oxidant and the consumed portion of the supply oxidant, wherein providing a supply oxidizer comprises providing a supply oxidizer that comprises a supply dilutant at a supply dilutant flow rate, and further wherein emitting an exhaust oxidizer comprises emitting an exhaust oxidizer that comprises an exhaust dilutant at an exhaust dilutant flow rate that corresponds to the supply dilutant flow rate.

24. The method of claim 18, wherein emitting an exhaust oxidizer comprises continuously releasing the exhaust oxidizer to the stack exhaust.

25. The method of claim 18, wherein providing a supply oxidizer comprises providing a supply oxidizer that comprises a supply oxidant at a supply oxidant flow rate and a supply dilutant at a supply dilutant flow rate that has a predetermined ratio to the supply oxidant flow rate.

26. The method of claim 18, wherein providing a supply fuel comprises providing a supply fuel comprising hydrogen gas.

27. A method of operating a fuel cell stack assembly, the method comprising:
providing a supply fuel to the fuel cell stack assembly;
providing a supply oxidizer to the fuel cell stack assembly, the supply oxidizer comprising a supply dilutant and a supply oxidant;
consuming a portion of the supply fuel and a portion of the supply oxidant to produce an electric current therefrom;
generating a measurement of the electric current produced by the fuel cell stack assembly;
determining a consumption rate of the supply oxidant based upon the measurement of the electric current;
emitting an exhaust oxidizer to a stack exhaust, the exhaust oxidizer comprising an exhaust dilutant and an exhaust oxidant;
determining a minimum exhaust dilutant flow rate based upon the consumption rate of the supply oxidant;
determining an exhaust fuel flow rate;
determining a fuel dilution factor that is a ratio of the exhaust fuel flow rate to the minimum exhaust dilutant flow rate;
generating at least one command signal comprising at least a functional fuel purge command signal that is adapted to actuate a fuel purge module to be selectively actuated, in response to the fuel purge command signal, to regulate a volume of the exhaust fuel that is released into the stack exhaust; and
generating an interlock fuel purge command signal to actuate the fuel purge module to transition to form an open configuration to a closed configuration, in which the fuel purge module is adapted to prevent exhaust fuel from being released into the stack exhaust, when the fuel dilution factor exceeds a threshold value.

28. The method of claim 27, wherein generating an interlock fuel purge command signal comprises generating a fuel source cutoff command signal that is adapted to actuate a fuel source cutoff module to be transitioned from an open configuration, in which the supply fuel is provided to the fuel cell stack assembly, to a closed configuration, in which the fuel source cutoff module prevents the supply fuel from being provided to the fuel cell stack assembly.

29. The method of claim 27, wherein the fuel has a lower flammability limit, and further wherein generating an interlock fuel purge command signal comprises generating the interlock fuel purge command signal to actuate the fuel purge module to transition to the closed configuration when the fuel dilution factor exceeds a predetermined fraction of the lower flammability limit of the fuel.

30. The method of claim 27, wherein generating the interlock fuel purge command signal comprises generating an interlock command signal that is adapted to cause the fuel cell stack assembly to enter a control state in which the functional fuel purge command signal to actuate the fuel purge module to transition to the open configuration is not generated until specific user actions with the fuel cell stack assembly are performed.

31. The method of claim 27, wherein determining an exhaust fuel flow rate comprises determining a time-averaged exhaust fuel flow rate, wherein generating an interlock fuel purge command signal comprises generating the interlock fuel purge command signal to control the fuel purge module to maintain the fuel dilution factor below the threshold value, wherein the fuel purge module is adapted to be selectively actuated, in response to the fuel purge command signal, to be selectively transitioned between an open configuration, in which the fuel purge module is adapted to release a volume of the exhaust fuel to the stack exhaust, and a closed configuration, in which the fuel purge module is adapted to prevent the exhaust fuel from being released into the stack exhaust.

32. The method of claim 27, wherein providing a supply fuel comprises providing a supply fuel comprising hydrogen gas.
